(19) United States
(12) Patent Application Publication
(10) Pub. No.: US 2006/0209059 A1
(43) Pub. Date: Sep. 21, 2006

(54) Image forming apparatus

(76) Inventor: Kazuya Iwasaki, Saitama (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(21) Appl. No.: 11/362,080

(22) Filed: Feb. 27, 2006

(30) Foreign Application Priority Data
Mar. 18, 2005 (JP) 2005-078490

(51) Int. Cl. G09G 5/00

(52) U.S. Cl. 345/211

(57) ABSTRACT

An image forming apparatus includes an operating unit including a flat panel display that displays information for a user. The flat panel display maintains displaying displayed information even after power for driving the flat panel display is shut off.

### CROSS-REFERENCE TO RELATED APPLICATIONS

The present document incorporates by reference the entire contents of Japanese priority document, 2005-078490 filed in Japan on Mar. 18, 2005.

### BACKGROUND OF THE INVENTION

1. Field of the Invention

The present invention relates to an image forming apparatus, and more particularly to an operation panel of an image forming apparatus.

2. Description of the Related Art

In recent years energy saving in image forming apparatuses is in increasing demand throughout the world, and there is a standard that power consumption in an energy-saving mode is equal to or less than five Watts, and a recovery time to recover a normal operation mode and a shifting time to a standby condition in the energy-saving mode from a normal operating condition are equal to or less than 10 seconds.

Conventionally, in such energy-saving mode, only a part of the configuration of the apparatus such as a part for monitoring a factor to recover the normal operation mode is actuated by applying current. The power of most other parts including an operation panel is cut.

However, in such a setting that an apparatus shifts to the energy-saving mode in a predetermined short time, giving priority to an energy-saving effect, if an operator does not perform operation for the predetermined time with some reasons, the apparatus shifts to the energy-saving mode even though it is still in the middle of operation for the operator. Thus, the power of the operation panel is shut off, and a setting screen is no longer displayed or a setting mode is cancelled to display a normal display condition. This causes inconveniences for a user.

In an operation panel, the power is mostly consumed by a backlight of a liquid crystal display screen, such as a cold-cathode tube and a white light-emitting diode (LED). The second most consumption is LED lamps that indicate various conditions.

In a technology disclosed in, for example, Japanese Patent Application Laid-Open Nos. H6-27440 and H11-126118, to save power, luminance of a backlight is controlled by changing output of a backlight driving inverter depending on brightness of ambient light.

However, in the technology, output of an inverter that is basically inefficient is controlled. This cannot achieve absolute energy savings. Moreover, basically, it is impossible to completely turn off the backlight, if a transmissive liquid crystal is used.

On the other hand, development of a paper-like display, electronic paper, using elcctrophoresis and charged particles has been developed recently, and a display having a display memory effect not requiring electric power for a display, except when rewriting display data, has been proposed.

Such display requires no backlight unit since surface reflectivity is high. If a display having such low-power consumption characteristics is applied to an operation panel of an image forming apparatus, a further reduction of power consumption in an energy-saving mode is expected.

### SUMMARY OF THE INVENTION

It is an object of the present invention to at least solve the problems in the conventional technology.

An image forming apparatus according to one aspect of the present invention includes an operating unit. The operating unit includes a display configured to display information for a user. The display is configured to maintain displaying displayed information even after power for driving the display is shut off.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a schematic of an operation panel of an image forming apparatus according to an embodiment of the present invention;

FIG. 2 is a block diagram of the image forming apparatus;

FIG. 3 is a schematic of a display on an operation panel; and

FIG. 4 is a schematic of another display on the operation panel.

### DETAILED DESCRIPTION OF THE PREFERRED EMBODIMENTS

Exemplary embodiments according to the present invention will be explained in detail below with reference to the accompanying drawings.

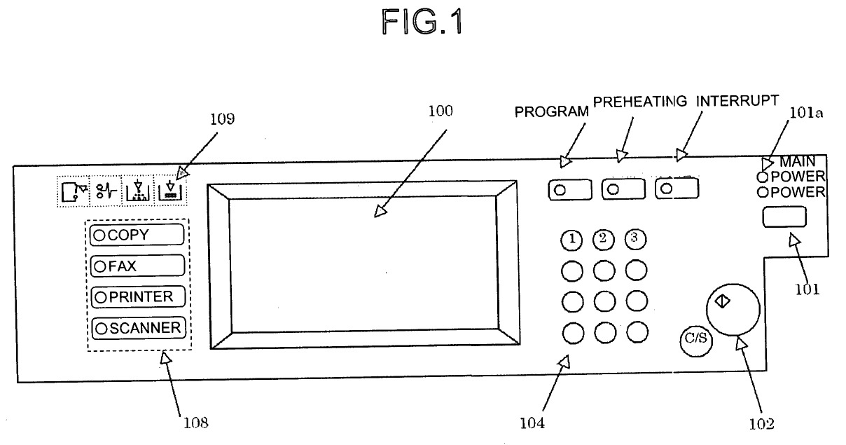

FIG. 1 is a schematic of an operation panel of an image forming apparatus according to an embodiment of the present invention. The operating panel has hard keys such as a numeric keypad 104, a start key 102, an application switching key 108, and a power key 101, and LED display sections such as an alert display section 109 and a main-power indicator 101a.

The operation panel also has a display unit 100 that includes a display 100a that displays an apparatus condition and a touch panel 100b provided on the display 100a to input to soft keys. A paper-like display having a display memory effect is used as the display 100a.

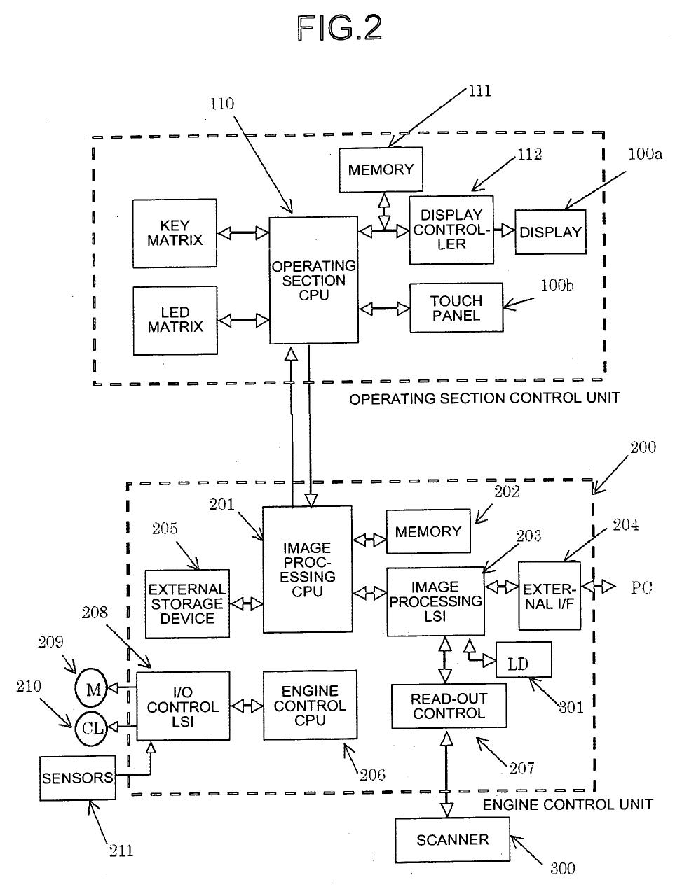

Control of the operation panel is, as shown in FIG. 2, carried out by an operating section control unit, and the operating section control unit is connected via a communication line with an engine control unit that controls a main operation as an image forming apparatus. The operating section control unit is configured to carry out an image formation in a mode set by inputting with the hard keys and soft keys and to display a condition of the engine control unit side at the operating section control unit side.

The operating section control unit includes an operating section central processing unit (CPU) 110, a display memory 111, and a display controller 112.

The engine control unit includes an image processing CPU 201, an image memory 202, and an image processing large-scale integration (LSI) 203. The engine control unit processes a copy image from a scanner 300, print data from a personal computer (PC), and the like, performs lighting control of a laser diode (LD) 301, and forms an image on a transfer paper by an imaging process. The engine control unit also has an engine control CPU 206 that performs, based on sensor information of an imaging engine, a drive control of the imaging engine through an input/output (IO) control LSI 208 and performs conveyance control of an original document or a transfer paper.

The image forming apparatus shifts to an energy-saving mode when a key input has not been performed for a predetermined time (for example, one minute) or when the power key 101 is pressed.

When the image processing CPU 201 detects that the power key 101, which has been monitored by the image processing CPU 201, is pressed, the image processing CPU 201 issues an instruction to the operating section CPU 110 to display data indicative of an energy-saving mode.

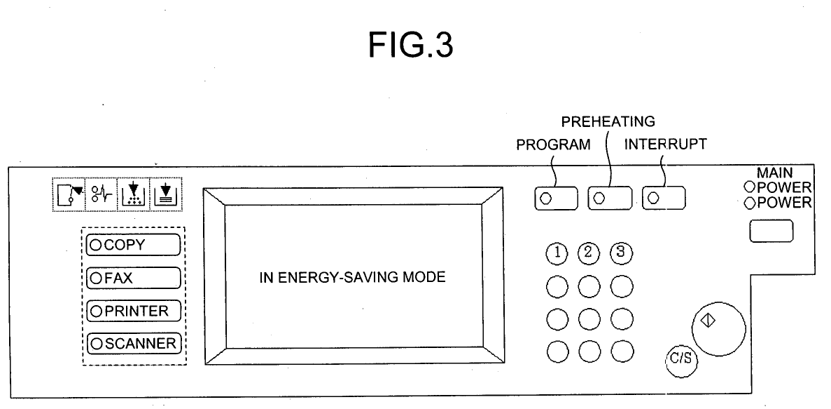

The operating section CPU 110 causes the display memory 111 to display “In energy-saving mode” as shown in FIG. 3, and issues an instruction to the display controller 112 to end displaying.

The display controller 112 forwards display data to the display 100a from the display memory 111 together with a display control signal when the instruction arrives, stops the display control signal when forwarding finishes, and issues a forwarding end signal to the operating section CPU 110.

The operating section CPU 110 notifies the image processing CPU 201 of a display completion when receiving the forwarding end signal. The image processing CPU 201 outputs, when receiving the notice of a display completion, a control signal to a power unit to shut off power supply to control units other than the image processing CPU 201. Thus, the image forming apparatus shifts to the energy-saving mode.

Although power of the operating panel is also shut off, the display 100a can maintain a display indicating that the image forming apparatus is in an energy-saving mode since the display 100a has a display memory effect.

A shift to an energy-saving mode when there is no key input for a prescribed time (for example, one minute) is the same except for that a timer interrupt serves as a trigger in place of pressing the power key 101.

When the power key 101 is pressed in an energy-saving mode and the image processing CPU 201 detects press of the power key 101, the image processing CPU 201 issues a power-on instruction to the power unit to start power supply to respective control units for recovery.

When it is detected that the operating section CPU 110 has recovered based on establishment of communication, the operating section CPU 110 is instructed to display an initial screen of a prioritized application, and similar to the foregoing, the operating section CPU 110 draws display data on the display memory 111 and carries out a display on the display 100a by the display controller 112.

When an image forming apparatus is applied to a high-performance multifunction product provided with a copying function, a facsimile function, a printer function, and the like in a complex manner, since such a multifunction product usually has a large display area, contents of a display in an energy-saving mode can be expanded to a more detailed information rather than just displaying “In energy-saving mode” as shown in FIG. 3.

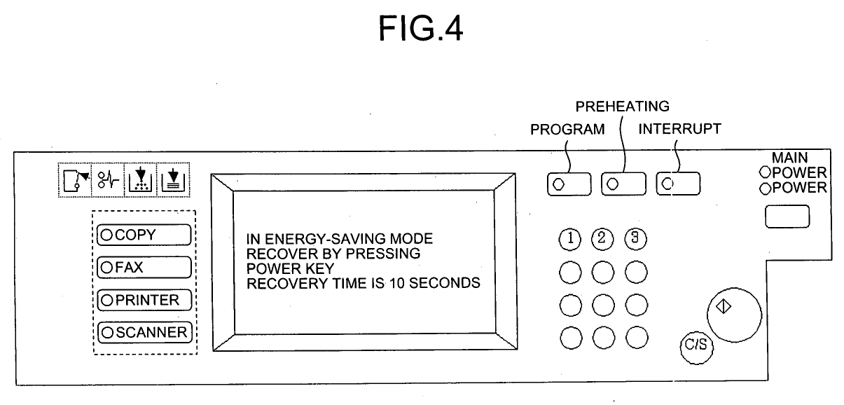

When the image processing CPU 201 detects that the power key 101 has been pressed, this issues an instruction to the operating section CPU 110 to display data indicative of an energy-saving mode. As shown in FIG. 4, the operating section CPU 110 draws a display (“in energy-saving mode”) showing an energy-saving mode, a recovery method (“recover by pressing power key”), and recovery time required to recover from the energy-saving mode (“recovery time is 10 minutes”) on the display memory 111, and issues an instruction to the display controller 112 to end drawing. Graphical information may be displayed to show a position of the power key 101 for easy understanding of the recovery method.

The display controller 112 forwards display data to the display 100a from the display memory 111 together with a display control signal when the instruction arrives, stops the display control signal when forwarding finishes, and issues a forwarding end signal to the operating section CPU 110.

The operating section CPU 110 notifies the image processing CPU 201 of a display completion when receiving the forwarding end signal. The image processing CPU 201 outputs, when receiving the notice of a display completion, a control signal to the power unit to shut off power supply to control units other than the image processing CPU 201. Thus, the image forming apparatus shifts to the energy-saving mode.

Although power of the operating panel is also shut off, the display 100a can maintain a display indicating that the image forming apparatus is in an energy-saving mode since the display 100a has a display memory effect.

A shift to an energy-saving mode when there is no key input for a prescribed time (for example, one minute) is the same except for that a timer interrupt serves as a trigger in place of pressing the power key 101.

Thus, it becomes clear for a user that the image forming apparatus is in an energy-saving mode, and power consumption in the energy-saving mode can be reduced.

It should be understood that, although a best mode for carrying out the present invention has been explained in the above, the invention is not limited to the foregoing, and various modifications can be made without departing from the spirit and scope of the invention.

According to the embodiments described above, it is possible to reduce power consumption.

Moreover, according to the embodiments described above, it is possible to prevent an operational error while maintaining a high energy-saving effect.

Furthermore, according to the embodiments described above, it is possible to improve convenience in use.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image forming apparatus comprising
an operating unit including a display configured to display information for a user, wherein
the display is configured to maintain displaying displayed information even after power for driving the display is shut off.

2. The image forming apparatus according to claim 1, wherein
the operating unit is configured to be operated in a normal operation mode and an energy-saving mode that are switched therebetween based on predetermined factors, the energy-saving mode in which power supply to the operating unit is shut off, and
the display is configured to display, when the operating unit is switched to the energy-saving mode, information indicating that the operating unit is in the energy-saving mode, before power supply to the display is shut off.

3. The image forming apparatus according to claim 1, wherein
the operating unit is configured to be operated in a normal operation mode and an energy-saving mode that are switched therebetween based on predetermined factors, the energy-saving mode in which power supply to the operating unit is shut off, and
the display is configured to display, when the operating unit is switched to the energy-saving mode, information indicating that the operating unit is in the energy-saving mode, a method of recovering from the energy-saving mode, and an estimated time to recover the normal operation mode, before power supply to the display is shut off.
